(19) United States
(12) Patent Application Publication
(10) Pub. No.: US 2025/0392719 A1
(43) Pub. Date: Dec. 25, 2025

(54) IMAGE PROCESSING APPARATUS AND CONTROL METHOD THEREFOR

(71) Applicant: CANON KABUSHIKI KAISHA, Tokyo (JP)

(72) Inventor: RYOTA SUZUKI, Tokyo (JP)

(21) Appl. No.: 19/305,420

(22) Filed: Aug. 20, 2025

Related U.S. Application Data
(63) Continuation of application No. PCT/JP2024/005579, filed on Feb. 16, 2024.

(30) Foreign Application Priority Data
Feb. 27, 2023 (JP) 2023-028843

(51) Int. Cl. H04N 19/124; G06T 19/00; H04N 19/176; H04N 19/63

(52) U.S. Cl. CPC H04N 19/124; G06T 19/006; H04N 19/176; H04N 19/63

(57) ABSTRACT

Disclosed is an image processing apparatus that obtains an image, from an image sensor, the image being formed by first and second optical systems for capturing a VR image, and encodes the image. The image processing apparatus quantizes image data obtained by the image sensor in units of a block of a predetermined size, determines a quantization parameter used in the quantization, sets the quantization parameter, and encodes post-quantization data. The image processing apparatus determines a quantization parameter of a quantization target block based on a position of a quantization target block and on positions and the sizes of the two respective circular images that are included in the VR image and are formed by the first and second optical systems.

### CROSS-REFERENCE TO RELATED APPLICATIONS

This application is a Continuation of International Patent Application No. PCT/JP2024/005579, filed Feb. 16, 2024, which claims the benefit of Japanese Patent Application No. 2023-028843, filed Feb. 27, 2023, both of which are hereby incorporated by reference herein in their entirety.

### BACKGROUND

### Field of the Technology

The present disclosure relates to an image processing apparatus and a control method therefor, and particularly to a technique to encode images.

### Description of Related Art

There is a known technique for displaying a three-dimensional VR (Virtual Reality) image by mapping and displaying, on a virtual sphere, a parallax image pair with a large angle of view that has been obtained using two optical systems. A dual-eye VR camera for shooting this VR image includes two optical systems facing the same direction. Then, the dual-eye VR camera records, in single shooting, an image including two side-by-side subject images with parallax, which are formed by the two optical systems on a single sensor, as the VR image.

As a related technique, Japanese Patent Laid-Open No. 2022-46260 describes a method of placing two subject images with parallax side by side, and recording them via one sensor.

However, according to the conventional technique disclosed in the aforementioned Japanese Patent Laid-Open No. 2022-46260, a specific method of compression encoding of a VR image is not disclosed. In order to comfortably view a VR image and a VR video, it is necessary to perform recording with high resolution at a high frame rate, which leads to a problem of an increase in the amount of recorded data.

### SUMMARY

The present disclosure in its aspect provides a technique to encode a data amount at the time of recording of a VR image at a high compression ratio while suppressing deterioration in the image quality of an image to be displayed.

According to an aspect of the disclosure, there is provided an image processing apparatus that obtains an image from an image sensor, the image being formed by first and second optical systems for capturing a VR image, and encodes the image, comprising one or more processors that execute a program stored in a memory and thereby function as: a quantization unit configured to quantize image data obtained by the image sensor in units of a block of a predetermined size; a quantization control unit configured to determine a quantization parameter used by the quantization unit, and set the quantization parameter in the quantization unit; and an encoding unit configured to encode post-quantization data obtained by the quantization unit, wherein the quantization control unit includes a calculation unit configured to calculate positions and sizes of two circular images which have been formed by the first and second optical systems and which are included in the VR image, and a determination unit configured to determine a quantization parameter of a quantization target block based on a position of the quantization target block and on the positions and the sizes of the two respective circular images.

According to another aspect of the disclosure, there is provided a control method for an image processing apparatus that obtains an image, from an image sensor, the image being formed by first and second optical systems for capturing a VR image, and encodes the image, comprising: quantizing image data obtained by the image sensor in units of a block of a predetermined size; determining a quantization parameter used in the quantization step; setting the quantization parameter in the quantizing step; and encoding post-quantization data obtained in the quantizing, wherein the determining includes calculating positions and sizes of two circular images which have been formed by the first and second optical systems and which are included in the VR image, and determining a quantization parameter of a quantization target block based on a position of the quantization target block and on the positions and the sizes of the two respective circular images.

According to a further aspect of the disclosure, there is provided a computer-readable medium storing a program that causes, when executed by one or more processors, the one or more processors to perform a control method for an image processing apparatus that obtains an image, from an image sensor, the image being formed by first and second optical systems for capturing a VR image, and encodes the image, comprising: quantizing image data obtained by the image sensor in units of a block of a predetermined size; determining a quantization parameter used in the quantization step; setting the quantization parameter in the quantizing step; and encoding post-quantization data obtained in the quantizing, wherein the determining includes calculating positions and sizes of two circular images which have been formed by the first and second optical systems and which are included in the VR image, and determining a quantization parameter of a quantization target block based on a position of the quantization target block and on the positions and the sizes of the two respective circular images.

Features of the present disclosure will become apparent from the following description of embodiments with reference to the attached drawings.

### BRIEF DESCRIPTION OF THE DRAWINGS

FIG. 1 is a block configuration diagram of an image processing apparatus according to a first embodiment.

FIG. 2 is a diagram for describing a VR image.

FIG. 3 is a diagram for describing the Bayer array.

FIG. 4 is a diagram for describing the wavelet transform.

FIG. 5 is a block configuration diagram of a quantization control unit according to the first embodiment.

FIG. 6 is a diagram for describing a spatial positional relationship between pixels and coefficients after the wavelet transform, and a unit of quantization control.

FIG. 7 is a diagram for describing various types of parameters composing a VR image.

FIG. 8 is a diagram showing setting examples of quantization parameter correction amounts according to the first embodiment.

FIG. 9 is a flowchart showing a procedure of determination of a quantization parameter correction amount by a control unit according to the first embodiment.

FIG. 10 is a diagram for describing a unit of calculation of feature information by the quantization control unit according to the first embodiment.

FIG. 11 is a diagram showing examples of setting of quantization parameter correction amounts by the quantization control unit according to the first embodiment.

FIG. 12 is a flowchart showing a procedure of determination of a quantization parameter correction amount by the quantization control unit according to the first embodiment.

FIG. 13 is a flowchart showing a procedure of outputting of a quantization parameter by a quantization parameter correction unit according to the first embodiment.

FIG. 14 is a flowchart showing a procedure of determination of a quantization parameter correction amount by a control unit according to a second embodiment.

FIG. 15 is a block configuration diagram of an image processing apparatus according to the second embodiment.

### DESCRIPTION OF THE EMBODIMENTS

Below, embodiments will be described in detail with reference to the attached drawings. Note that the following embodiments do not limit the scope of the claims. Although a plurality of features are described in embodiments, not all of these plurality of features are indispensable for the embodiments, and in addition, the plurality of features may be combined in any way. Furthermore, in the attached drawings, the same or similar configurations are provided with the same reference numerals, and duplicate descriptions are omitted.

### First Embodiment

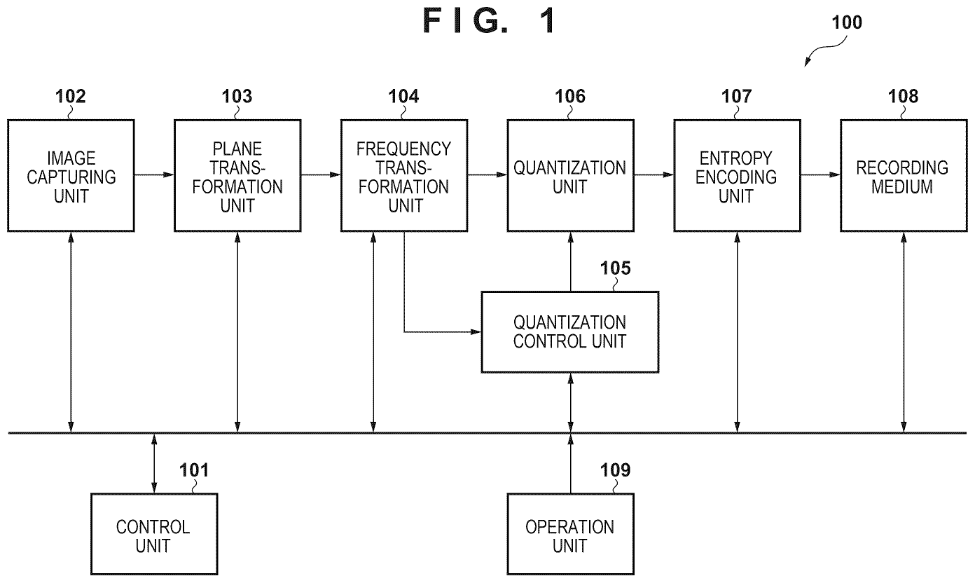

FIG. 1 shows a configuration of an image processing apparatus 100 according to a first embodiment. The image processing apparatus 100 is composed of a control unit 101, an image capturing unit 102, a plane transformation unit 103, a frequency transformation unit 104, a quantization control unit 105, a quantization unit 106, an entropy encoding unit 107, a recording medium 108, and an operation unit 109.

The control unit 101 is composed of a CPU, a ROM that stores a program executed by the CPU, and a RAM that is used by the CPU as a working area. This ROM also stores, for example, later-described lens information that is information unique to lenses, in addition to the program. Note that in a case where lenses are removable and attachable, the lens information may be stored in a memory (ROM) provided inside the lenses.

The image capturing unit 102 includes optical systems with dual-eye lenses, which are capable of shooting a left image and a right image with parallax, and an image sensor. These dual-eye lenses are interchangeable lenses for VR180 that capture a VR image that enables dual-eye stereopsis. The lenses for VR180 form a right image which is obtained via a right-eye optical system, and a left image which is obtained via a left-eye optical system and which exhibits parallax relative to the right image, on one image sensor so that they are lined up on the left and right. The image processing apparatus 100 according to embodiments encodes and records captured data in a RAW format that has been obtained via the image sensor. Hereinafter, an image including the left and right images formed on one image sensor will be referred to as a VR image.

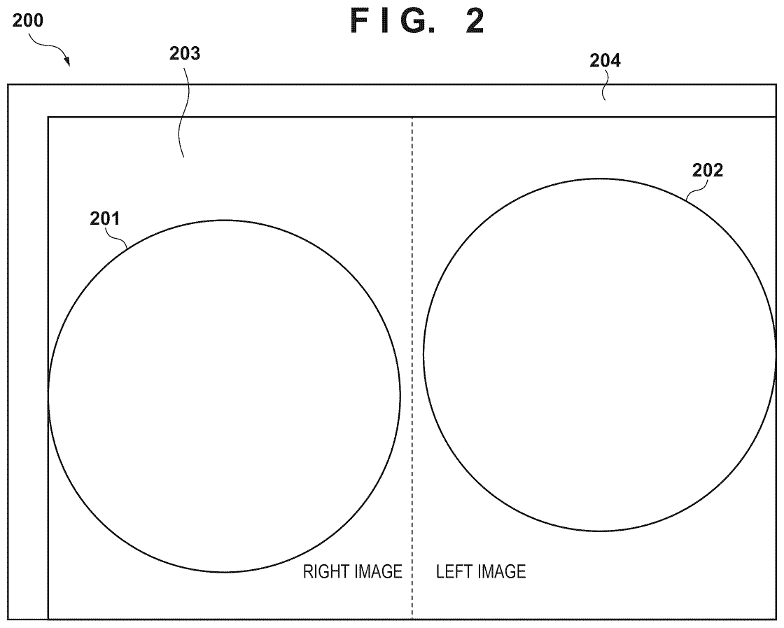

FIG. 2 shows an example of a VR image captured by the image capturing unit 102. The VR image 200 is a circular fisheye image (also simply referred to as a circular image), and includes a right image 201 obtained by the right-eye optical system and a left image 202 obtained by the left-eye optical system. Each of the right image 201 and the left image 202 exhibits a larger optical distortion with a decreasing distance to an outer circumference of an image circle. An area 203 that is further outside the outer circumferences of the image circles is a shaded area. Furthermore, an area 204 which is called an optical black area (hereinafter, an OB area), and which is used only for various types of correction processing, such as development, is appended to an upper edge and a left edge of the VR image 200. The OB area 204 is generally appended to an edge of a captured image; in the present embodiment, it will be described as being appended to the left edge and the upper edge as shown in the figure. By applying geometric transformation processing, such as perspective projection transformation processing and equirectangular projection transformation processing, to the VR image 200, the VR image 200 can be displayed as a natural image on an HMD (Head Mount Display), a monitor, and the like. In the aforementioned geometric transformation processing, the shaded area 203 is not used as a display area, and the right image 201 and the left image 202 are used as display areas. When displayed on an HMD and the like, the outer circumference area of each of the right image 201 and the left image 202 is significantly stretched. Therefore, in processing for encoding the VR image, encoding that places priority on reduction in the amount of codes (or encoding that assigns relatively few codes) is performed with respect to areas inside the image circles of the right image 201 and the left image 202, and encoding that places priority on the image quality for suppressing deterioration in the image quality caused by stretching (or encoding that assigns more codes) is performed for the outer circumference areas inside the image circles. Moreover, it is important to increase the encoding efficiency by reducing codes assigned to the shaded area 203, which is redundant data. To this end, it is necessary to separate the left image 201, the right image 202, the shaded area 203, and the OB area 204 from one another, and set an appropriate quantization parameter for each separated area.

Considering that the left and right images are circular fisheye images, it is possible to separate the left and right images 201, 2, and 202 and the shaded area 203 from one another by using central coordinates of the left image 201 and the right image 202, and information of image circle diameters held as the lens information. Furthermore, with respect to the OB area 204 as well, sensor information holds how many pixels are appended to which image end, and therefore separation of the OB area 204 is also possible as long as the number of such pixels is known. In view of the above, a configuration of each unit and operations thereof will be described.

The control unit 101 executes control on each processing unit composing the image processing apparatus 100, computation processing, and the like.

Also, the control unit 101 determines a compression ratio in accordance with a shooting setting designated by a user via the operation unit 109, and outputs information of the compression ratio to the later-described quantization control unit 105.

Furthermore, in order to separate the right image, the left image, and the shaded area inside a VR image obtained from the later-described image capturing unit 102 from one another, the control unit 101 calculates central coordinates and the like of each of the right image and the left image. Regarding such central coordinates, due to the occurrence of a center displacement caused by a lens manufacturing error, lens attachment and removal, and inclination of a housing at the time of image capture, it is necessary to calculate coordinates that take such a center displacement into consideration.

The manufacturing error includes, for example, a correction coefficient so as to eliminate individual differences in optical performance from a chart measurement result at the time of factory shipment, and is stored as lens information. The control unit 101 calculates coordinate displacement amounts of forming points from this lens information. The lens information includes ideal central coordinates of the left and right images on an image forming plane. The control unit 101 calculates central coordinates of each of the right image and the left image that take into consideration the displacements of central coordinates by summing the ideal central coordinates of the left and right images, which have been obtained from the lens information, and the aforementioned coordinate displacement amounts.

The attachment and removal error includes coordinate displacement amounts of the left and right images at the time of lens attachment and removal. In practice, when image capture has been performed while the lenses are attached, the control unit 101 performs pattern matching with respect to the right image and the left image in the image capture result, and calculates coordinate displacement amounts in the horizontal, vertical, and rotation directions of a case where the difference between feature points is the smallest in each image. The control unit 101 calculates central coordinates of the right image and the left image that take into consideration the displacements of central coordinates by summing the ideal central coordinates of the left and right images, which have been obtained from the lens information, and the aforementioned coordinate displacement amounts.

Regarding inclination of the housing at the time of image capture, inclination of the housing can be detected using, for example, a non-illustrated gyro sensor and the like. The control unit 101 calculates coordinate displacement amounts in the horizontal, vertical, and rotation directions in accordance with the detected inclination. Then, similarly to the attachment and removal error, the control unit 101 calculates central coordinates of the right image and the left image that take into consideration the displacements of central coordinates by summing the ideal central coordinates of the left and right images, which have been obtained from the lens information, and the aforementioned coordinate displacement amounts.

Once the central coordinates of each of the right image and the left image on the image sensor have been determined in the foregoing manner, the control unit 101 determines quantization parameter correction amounts in accordance with a distance to a quantization target block of a predetermined size, and outputs them to the later-described quantization control unit 105. The details related to a method of determining the quantization parameter correction amounts will be described later.

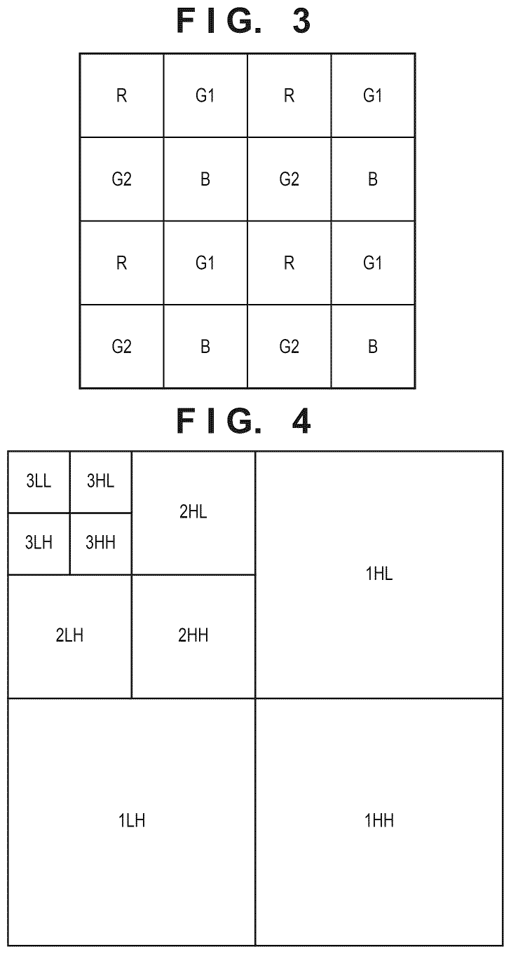

The image capturing unit 102 includes a lens optical system capable of optical zooming, which includes an optical lens, a diaphragm, and focus control and lens driving units, and an image sensor, like a CCD or CMOS sensor, that transforms optical information from the lens optical system into electrical signals. Then, the image capturing unit 102 outputs RAW image data (a VR image), which is electrical signals obtained by the image sensor and transformed into digital signals, to the plane transformation unit 103. Note that as stated earlier, the image capturing unit 102 includes optical systems with dual-eye lenses, forms a right image and a left image that are different in parallax on one sensor, and outputs the RAW image data. Furthermore, in the image sensor included in the image capturing unit 102 according to the present embodiment, filters colored in RGB are arranged regularly. It is assumed that the arrangement (array) of the colored filters according to embodiments is the Bayer array. The Bayer array denotes, for example, an array in which 2×2 pixels are composed of one R pixel, one B pixel, and two G pixels (G1, G2), and the pattern of such 2×2 pixels is repeated, as shown in FIG. 3.

The plane transformation unit 103 transforms the RAW image data input from the image capturing unit 102 into four independent pieces of plane data that are each composed of a single component. Then, the plane transformation unit 103 outputs the generated four pieces of plane data to the frequency transformation unit 104. Examples of a formula of transformation into plane data are indicated by the following formulae (1)-(4). The plane transformation unit 103 according to embodiments transforms the RAW image data into a plane Y that approximately represents luminance components, and planes C0, C1, and C2 that represent other three chrominance components, in accordance with formulae (1)-(4).

$$Y = ( R + G 1 + G 2 + B ) / 4 \qquad ( 1 )$$

$$C 0 = R - B \qquad ( 2 )$$

$$C 1 = ( G 0 + G 1 ) / 2 - ( R + B ) / 2 \qquad ( 3 )$$

$$C 2 = G 0 - G 1 \qquad ( 4 )$$

Note, provided that the number of pixels in the horizontal direction and the number of pixels in the vertical direction in the RAW image data are W and H, respectively, the size of each of the aforementioned planes Y, C0, C1, and C2 are W/2×H/2. Also, the aforementioned transformation is an example, and a method of transformation into plane data is not limited to this; for example, another method that separates data into R, G1, G2, and B and outputs them may be used. The plane transformation unit 103 supplies, for example, the planes Y, C1, C2, and C3 to the frequency transformation unit 104 in this order.

Each plane is input from the plane transformation unit 103 to the frequency transformation unit 104, which applies frequency transformation thereto. Then, the frequency transformation unit 104 outputs transformation coefficients generated through the frequency transformation to the quantization control unit 105 and the quantization unit 106.

Here, an example of the frequency transformation that uses the wavelet transform is shown in FIG. 4. FIG. 4 is a diagram of formation of sub-bands in a decomposition level 3 in which the wavelet transform has been executed three times in each of the vertical direction and the horizontal direction. In FIG. 4, the first number in “1HL” and the like indicates a decomposition level, and also indicates how many times the wavelet transform has been executed to obtain this sub-band. When the wavelet transform has been executed once, four sub-bands LL, HL, LH, and HH are generated. Then, from the second time onward, the wavelet transform is executed with respect to the sub sub-band LL obtained in the immediately preceding wavelet transform. The sub-bands LH, HL, and HH other than the sub-band LL represent high-frequency components.

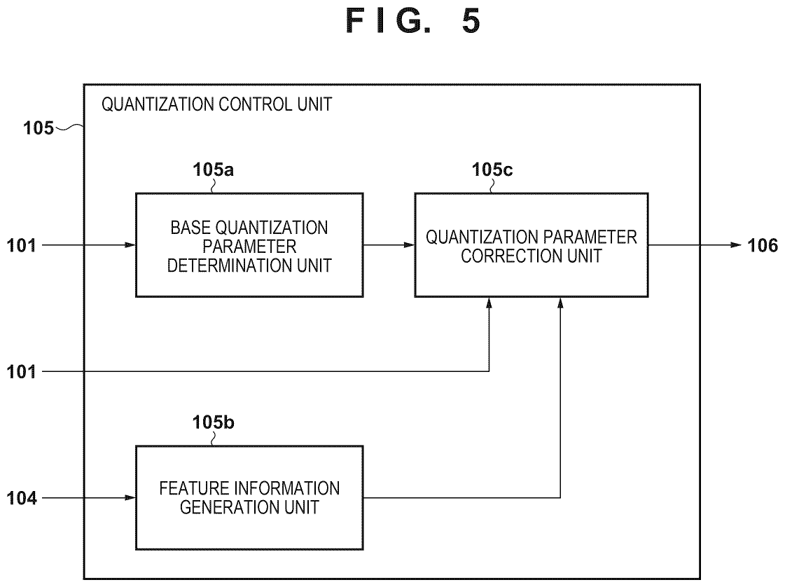

As shown in FIG. 5, the quantization control unit 105 includes a base quantization parameter determination unit 105a, a feature information generation unit 105b, and a quantization parameter correction unit 105c, and determines quantization parameters to be used in the quantization unit 106.

The base quantization parameter determination unit 105a determines quantization parameters to be applied to an entire screen based on a compression ratio input from the control unit 101. Then, the base quantization parameter determination unit 105a outputs the determined quantization parameters to the quantization parameter correction unit 105c.

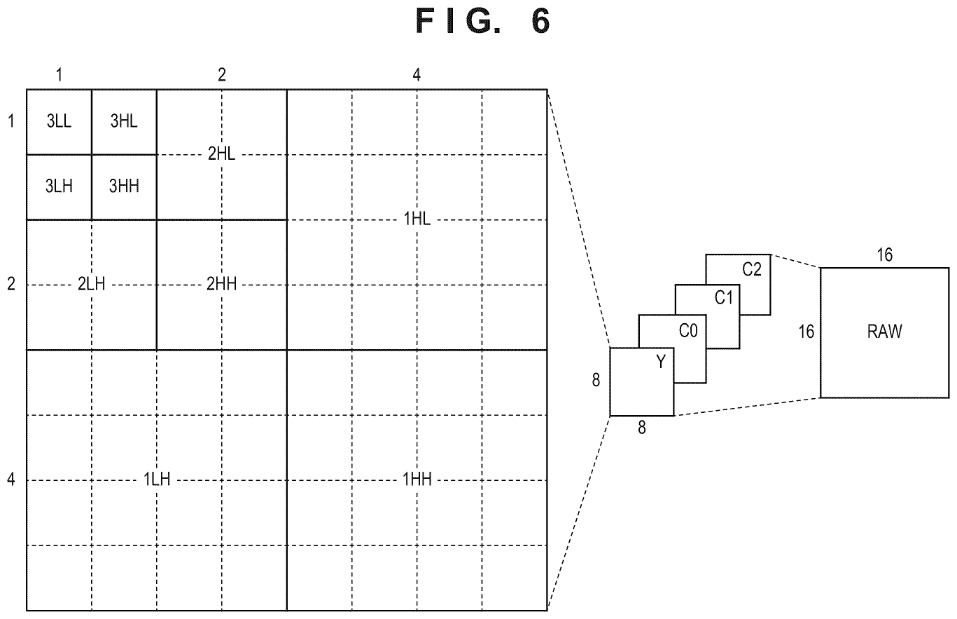

It is assumed that the frequency transformation unit 104 according to embodiments executes the wavelet transform of the RAW image data to the decomposition level 3. As shown in FIG. 6, ten sub-bands, namely 1HL, 1LH, 1HH, 2HL, 2LH, 2HH, 3HL, 3LH, 3HH, and 3LL, are generated from one plane. In embodiments, as four planes are generated from one piece of RAW image data, the number of sub-bands generated from one piece of RAW image data is 40. Then, the frequency transformation unit 104 supplies the generated 40 sub-bands to the quantization unit 106. Note that regarding the Y plane, the frequency transformation unit 104 supplies the sub-band 1LL to the quantization control unit 105, in addition to the generated sub-bands 1HL, 1LH, and 1HH. Although not shown in FIG. 4, this sub-band 1LL of the Y plane is obtained when the first wavelet transform has been executed, and is also the target of the second wavelet transform.

Regarding the aforementioned base quantization parameters, there is one parameter for the 40 sub-bands. In the wavelet transform, sub-sampling is performed in the horizontal and vertical directions in each decomposition level. Therefore, the 1×1 coefficient inside a sub-band of a decomposition level 3, a 2×2 coefficient inside a sub-band of a decomposition level 2, a 4×4 coefficient inside a sub-band of a decomposition level 1, 8×8 pixels in plane data, and furthermore, 16×16 pixels in the RAW image data in consideration of plane separation, correspond to areas that spatially have the same size.

Sub-band data and pixel data that are spatially at the same coordinates are the same unit of control on quantization parameters so as not to impair controllability of the image quality. In the present embodiment, it is assumed that the unit of control on quantization parameters is equivalent to 16×16 pixels in the RAW image data. Note that regarding the values of the base quantization parameters, statistical values that guarantee the image quality are prepared in tables for respective compression ratios, and a table to be referred to is switched in accordance with a compression ratio. Control is simplified by adopting a mechanism in which, once the base quantization parameters have been determined, a quantization parameter corresponding to each of 40 sub-bands is uniquely decided.

The feature information generation unit 105b calculates feature information for each of light and complexity using each piece of sub-band data in the Y plane input from the frequency transformation unit 104, and generates a quantization parameter correction amount based on them. Then, the feature information generation unit 105b outputs the generated quantization parameter correction amount to the quantization parameter correction unit 105c. The details related to a method of calculating feature information and a method of determining the quantization parameter correction amount will be described later.

The quantization parameter correction unit 105c corrects a base quantization parameter input from the base quantization parameter determination unit 105a by adding both of a first quantization parameter correction amount input from the control unit 101 and a second quantization parameter correction amount input from the feature information generation unit 105b to the base quantization parameter. Then, the quantization parameter correction unit 105c outputs the quantization parameter obtained through the correction to the quantization unit 106. The details related to a procedure of outputting the quantization parameter from the quantization parameter correction unit 105c will be described later.

The quantization unit 106 executes quantization with respect to sub-band data input from the frequency transformation unit 104 using the quantization parameter input from the quantization control unit 105, and outputs the post-quantization coefficients to the entropy encoding unit 107.

The entropy encoding unit 107 compresses and encodes the coefficients quantized by the quantization unit 106, and outputs encoded data to the recording medium 108. Although there are no particular restrictions on a type of this compression encoding, it is assumed that the compression encoding is carried out using entropy encoding, such as Golomb coding, for example.

The recording medium 108 is a recording medium composed of, for example, a nonvolatile memory. Encoded data output by the entropy encoding unit 107 is held as a file.

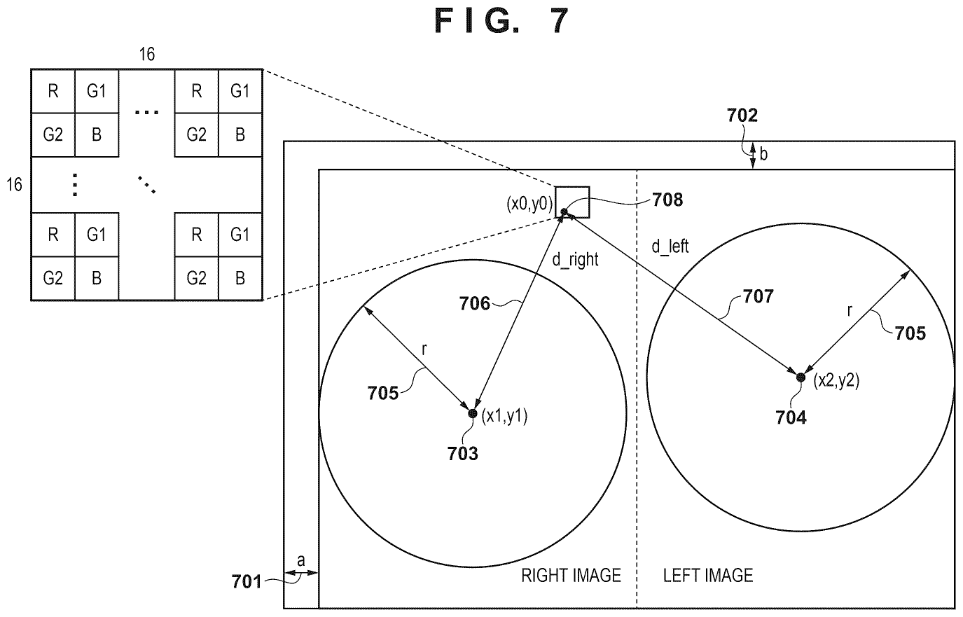

Here, various types of parameters related to a flow of determination of a first quantization parameter correction amount are shown in FIG. 7. FIG. 7 is a diagram of an overall configuration of a VR image captured by the image capturing unit 102; a description of contents that overlap with the description of FIG. 2 is omitted. Note that the position of coordinates at an upper-left corner of the VR image is the origin (0, 0), a horizontal axis shown in the figure is an X axis, and a rightward direction thereon is a positive direction. Also, similarly, a vertical axis is a Y axis, and a downward direction thereon is a positive direction.

Reference sign 701 is a horizontal size of the OB area 204, and this size is denoted by “a”. Reference sign 702 is a vertical size of the OB area 204, and this size is denoted by “b”. Reference sign 703 is the center of an image circle of a right image obtained by the right-eye optical system, and the coordinates thereof are denoted by (x1, y1). Reference sign 704 is the center of an image circle of a left image obtained by the left-eye optical system, and the coordinates thereof are denoted by (x2, y2). Reference signs 705 and 707 are radiuses of the circles of the left and right images (image circles), and a length thereof is denoted by r.

Reference sign 706 is a distance between a quantization target block (16×16 pixels) and the center 703 of the right image circle, and a length thereof is denoted by d_right. The quantization target block is 16×16 pixels (=256 pixels) of the Bayer array. In embodiments, the shortest distance among the distances between the pixels inside the quantization target block and the center 704 of the left image circle is denoted by d_right.

Reference sign 707 is a distance d_left between the quantization target block (16×16 pixels) and the center 704 of the left image circle. Similarly to d_right, d_left is the shortest distance between the quantization target block and the center 704 of the left image circle. Reference sign 708 is the pixel coordinates at the shortest distance from the centers of the left and right image circles, and these coordinates are denoted by (x0, y0). Reference sign 708 is the pixel coordinates that take the smallest value among d_right706 and d_left707. Parameters indicated by the aforementioned reference signs 701 to 708 are used to classify the left and right image circle areas, the shaded area, and the OB area. Hereinafter, a description is provided using the aforementioned parameters.

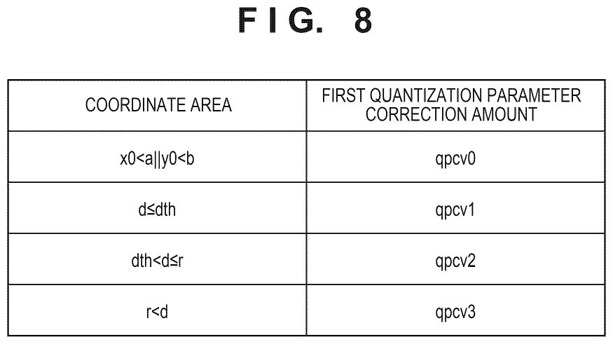

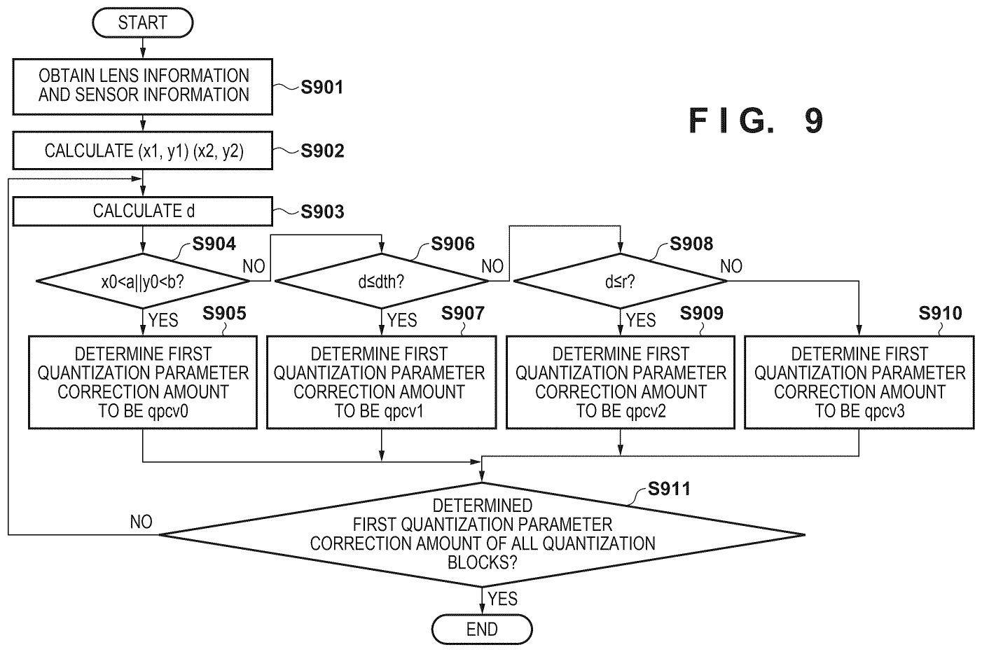

Next, the way to find a first quantization parameter correction amount will be described with reference to a table of FIG. 8. As stated earlier, in processing for encoding the VR image, it is important to separate the VR image into the left and right image circle areas, which are display areas, and non-display areas that are the shaded area and the OB area, and to set different quantization parameters for different areas. Furthermore, as the influence of deterioration in the image quality caused by geometric transformation varies even inside an image circle area, it is also necessary to separate an inner circumference part and an outer circumference part inside the image circle area from each other. The following indicates conditions of coordinates, or conditions of a distance from the central coordinates of the left and right image circles, for classifying the quantization target block into each area, which are shown in the first fields of FIG. 8.
OB area: x0<a or y0<b
Inner circumference area: d≤dth
Outer circumference area: dth<d≤r
Shaded area: r<d
In the aforementioned conditions, “dth” is a distance threshold for classification of the inner circumference area and the outer circumference area.

Next, a first quantization parameter correction amount will be described. Quantization parameter correction amounts in the second fields of FIG. 8 denote correction amounts for a base quantization parameter. Provided that the quantization parameter correction amounts for the respective areas are qpcv0 for the OB area 204, qpcv1 for the inner circumference area, qpcv2 for the outer circumference area, and qpcv3 for the shaded area 203, a magnitude relationship thereamong is set so as to satisfy the following relationship.

$$qpcv 2 \leq qpcv 1 \leq qpcv 0 \leq qpcv 3$$

Note that the larger the value of a correction amount, the higher the degree of deterioration in the image quality, and the higher the compression ratio. Conversely, the smaller the value of a correction amount, the lower the degree of deterioration in the image quality, and the lower the compression ratio.

Assume that the quantization parameter correction amount for the OB area 204 is the base (=0). As the inner circumference area and the outer circumference area are the display areas, the degree of importance of image quality thereof is higher than that of the OB area 204. Therefore, in order for qpcv1 an qpcv2 to achieve relatively fine quantization compared to qpcv0, negative values are set thereas. Even inside an image circle, the degree of importance of image quality is higher in the outer circumference area than in the inner circumference area in view of the aforementioned geometric transformation processing. Therefore, a negative value is set as qpcv2 so as to achieve even finer quantization than qpcv1. On the other hand, although the shaded area 203 is a non-display area similarly to the OB area 204, as it is a redundant area and is not used in the aforementioned development processing, the degree of importance of image quality thereof is lower than that of the OB area 204. Therefore, in order for qpcv3 to achieve relatively coarse quantization compared to qpcv0, a positive value is set thereas. Note that as the shaded area is a redundant area, a first quantization parameter correction amount that generates zero (or minimum) codes is set as qpcv3.

Next, processing for determining a first quantization parameter correction amount, which is executed by the control unit 101, will be described with reference to a flowchart of FIG. 9. In the present embodiment, as it is assumed that the wavelet transform is executed to the decomposition level 3, the size of a quantization target block is 16×16 pixels in RAW image data. Therefore, the control unit 101 scans (moves) a quantization block in units of 16 pixels in the horizontal and vertical directions.

In S901, the control unit 101 obtains lens information of the image capturing unit 102, sensor information, and housing inclination information. The lens information includes the ideal lens central coordinates of each of the right image and the left image, and a correction coefficient related to a lens manufacturing error. The sensor information includes a horizontal size and a vertical size of the OB area.

In S902, the control unit 101 calculates displacement amounts of the central coordinates using the lens information and the housing inclination information obtained in S901. Furthermore, the control unit 101 performs pattern matching with respect to the left and right images, and calculates coordinate displacement amounts of a case where the difference between feature points is the smallest in each image. The control unit 101 calculates central coordinates (x1, y1) and (x2, y2) of the left and right image circles inside the RAW image data that take into consideration a center displacement by summing these displacement amounts and the ideal lens central coordinates included in the lens information.

In S903, the control unit 101 calculates a distance d, which is the shortest distance to the central coordinates of one of the left and right image circles, using the central coordinates of the left and right image circles obtained in S902 and the coordinates of each pixel inside the quantization target block of interest.

To calculate d, first, the distance between one pixel inside the quantization target block of interest and the central coordinates of the image circle is calculated. This distance is regarded as d [idx]. Here, idx is an index of a pixel inside the quantization target block. In the case of the embodiment, the quantization target block is composed of 16×16 pixels, namely 256 pixels. Thus, idx is assigned inside the quantization target block in the raster scan order. That is to say, idx takes a value from 0 to 255. d [idx] is calculated using the coordinates (x, y) of a pixel inside the quantization target block, a distance d_right from the pixel inside the quantization target block to the central coordinates of the right image, and the distance d_left from the pixel to the central coordinates of the left image, in accordance with the following formulae (5) to (7).

$$d\_right = {( {( x - x 1 )}^{2} + {( y - y 1 )}^{2} )}^{1 / 2} \qquad ( 5 )$$

$${d\_left = ( {( x - x 2 )}^{2} + {( y - y 2 )}^{2} ) )}^{1 / 2} \qquad ( 6 )$$

$$d [ idx ] = MIN ( d\_right , d\_left ) \qquad ( 7 )$$

Here, MIN () is a function that returns the smallest value among given arguments.

The smallest value among d_right and d_left is assigned to d [idx]. The reason why the smallest value is assigned here will be described. In a case where the quantization target block is inside the left image circle, should the distance be calculated using the central coordinates of the right image circle, the quantization target block is classified into the shaded area as the distance to the central coordinates of the right image circle is long. Thus, in order to appropriately classify areas, it is always required to calculate the distance using the central coordinates of the image circle that is close to the quantization target block. Therefore, the smallest value among d_right and d_left is regarded as the distance d [idx]. In a case where the values of d_right and d_left are equal, either of them may be set as the distance d [idx].

The foregoing is the flow of calculation of a distance to one pixel inside the quantization target block, and the first pixel index d [0] is determined thereby. Then, the control unit 101 repeats this sequential flow for 16×16, namely a total of 256 pixels, thereby calculating up to d [255]. Once the control unit 101 has

finished calculating d [0]-d [255], it calculates the distance d using the following formula (8).

$$d = MIN ( d [ 0 ] , d [ 1 ] , d [ 2 ] , … , d [ 254 ] , d [ 255 ] ) \qquad ( 8 )$$

As shown in formula (8), the distance d, which is the shortest distance to the central coordinates of one of the left and right image circles, can be calculated by selecting the smallest value among the calculated distances to the 256 pixels. The purpose of selection of the shortest one of the distances to the inside of the quantization target block as the distance d is to classify the quantization target block into the image circle area in a case where the quantization target block straddles both the image circle area and the shaded area. As the image circle area is at a shorter distance from the center of the image circle than the shaded area is, selecting the shortest distance to the inside of the quantization target block inevitably classifies the quantization target block into the image circle area. This can suppress deterioration in the image quality of the image circle area in a case where the quantization target block straddles both the image circle area and the shaded area. Also, the pixel coordinates that minimize the distance from the center of the image circle to the inside of the quantization target block are (x0, y0).

In S904, the control unit 101 determines whether the quantization target block is in the OB area using information of the OB area obtained in S901. Specifically, in a case where x0 is smaller than a or y0 is smaller than b is satisfied, the control unit 101 determines that the quantization target block is in the OB area, and processing proceeds to S905. Also, in a case where the control unit 101 has determined that the quantization target block is outside the OB area, processing proceeds to S906. Note that in a case where a part of pixels inside the quantization target block is included in the OB area, the quantization target block is regarded to be in the OB area. This is for preventing the aforementioned development processing from being influenced by the execution of coarse quantization.

In S905, the control unit 101 determines that the quantization target block of interest is in the OB area, and determines the first quantization parameter correction amount thereof to be qpcv0.

S906 is processing in which the control unit 101 determines whether the quantization target block of interest is in the inner circumference area. Specifically, the control unit 101 compares the distance d with a preset threshold dth; processing proceeds to S907 in a case where it has determined that d is equal to or smaller than the threshold dth, and processing proceeds to S908 otherwise.

In S907, the control unit 101 determines that the quantization target block of interest is in the inner circumference area, and determines the first quantization parameter correction amount thereof to be qpcv1.

In S908, the control unit 101 determines whether the quantization target block of interest is in the outer circumference area by comparing the distance d with the distance r. In a case where the control unit 101 has determined that the distance d is equal to or shorter than the distance r, processing proceeds to S909; otherwise, processing proceeds to S910.

In S909, the control unit 101 determines that the quantization target block of interest is in the outer circumference area, and determines the first quantization parameter correction amount thereof to be qpcv2.

In S910, the control unit 101 determines that the quantization target block of interest is in the shaded area, and determines the first quantization parameter correction amount thereof to be qpcv3.

In S911, the control unit 101 determines whether the first quantization parameter correction amounts of all quantization target blocks have been determined. In a case where the control unit 101 has determined that the first quantization parameter correction amounts of all quantization target blocks have been determined, the present processing is completed. Also, in a case where the control unit 101 has determined that there is a quantization target block for which the first quantization parameter correction amount has not been determined yet, processing returns to S903, and the position of the next quantization target block is updated. Then, the control unit 101 regards the quantization target block after this position update as the quantization target block of interest, and executes the above-described processing.

Next, a description is given of a method of generation of feature information, which is for determining a second quantization parameter correction amount, by the feature information generation unit 105b. The feature information generation unit 105b makes a light and dark determination and a complexity determination in units of a predetermined wavelet coefficient in the Y plane (a rectangular block equal to or larger than 1 coefficient), calculates each feature amount, and generates a second quantization parameter correction amount corresponding to these feature amounts. In this regard, a more detailed description will be provided below.

Regarding light and dark, light indicates a luminance level of pixels. In quantization processing, if quantization is performed by using a relatively large quantization parameter with respect to a region of a dark area with a low luminance level, a coefficient after quantization easily becomes 0, and subtle information is easily lost. Therefore, in the region of the dark area, it is desirable that a quantization parameter be small to reduce quantization distortion. Also, in a region of a light area, it is desirable to perform quantization using a relatively large quantization parameter so that the amount of codes does not increase. The feature information generation unit 105b generates a correction amount for increasing or reducing a quantization parameter in accordance with light and dark areas.

Complexity indicates the magnitude of the spatial frequency of RAW data; a lower spatial frequency indicates a flatter area, and a higher spatial frequency indicates a more complex area. In image compression, a cutdown in information of a flat area makes visual deterioration more noticeable, whereas a cutdown in information of a complex area makes it difficult to notice visually. Therefore, it is desirable to use a relatively small quantization parameter in an area that includes a flat area. Furthermore, it is desirable to increase the encoding efficiency by using a relatively large quantization parameter in a complex area where visual deterioration is not likely to be noticeable. The feature information generation unit 105b generates a correction amount for increasing or reducing a quantization parameter in accordance with complexity.

Note that it is desirable to use the same unit of control as a unit of implementation of a second quantization parameter correction amount and a unit of generation of feature information so as not to impair controllability of the image quality. In the present embodiment, this unit of control is also the same as 16×16 pixels, which are the unit of calculation of a quantization parameter correction amount performed by the control unit 101, and the level 1 coefficient in the course of wavelet decomposition processing, which is the 4×4 coefficient, is used as a quantization block size, and is used as the unit of generation of a quantization parameter correction amount and feature information.

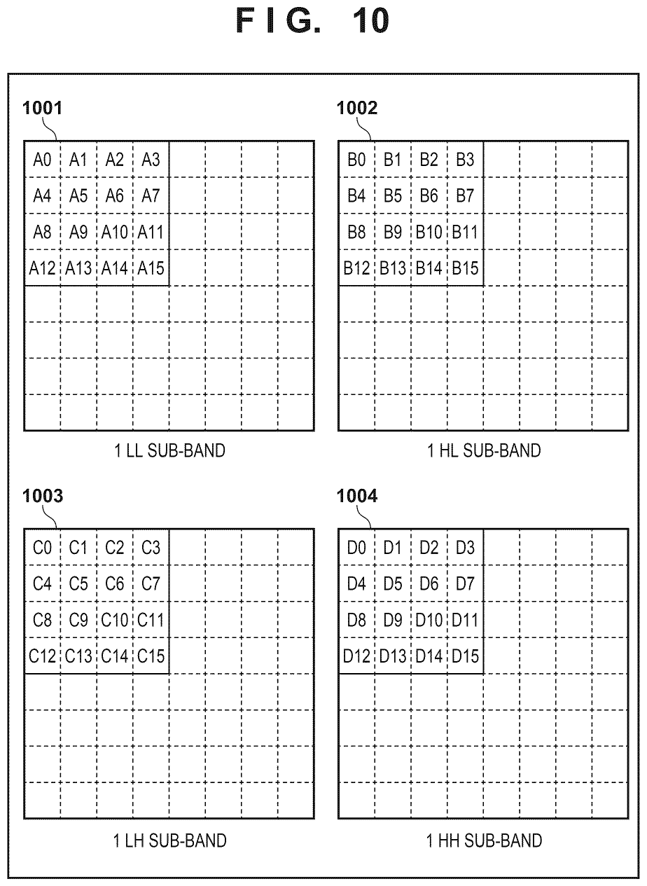

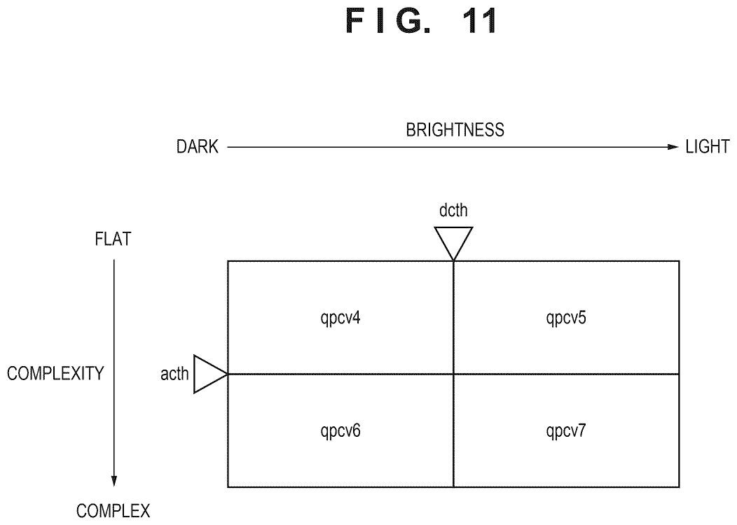

Here, a method of calculating a feature amount of each of light and complexity will be described with reference to FIG. 10.

The feature information generation unit 105b calculates a feature amount dc of light as an average value in a 4×4 coefficient block 1001 of a sub-band 1LL representing DC components of Y plane data, in accordance with the following formula (9).

$$d c = ( A 1 + A 2 + A 3 + … + A 15 + A 16 ) / 16 \qquad ( 9 )$$

It should be noted here that the sub-band ILL refers to an LL sub-band of the decomposition level 1, and is not the sub-band 3LL of FIG. 6.

The encoding efficiency of high-frequency components is poor. That is to say, it is sufficient to consider that the amount of high-frequency components is synonymous with complexity. In view of this, a feature amount ac of complexity is calculated using sub-bands 1HL, 1LH, and 1HH representing AC components (high-frequency components) of the Y plane data. Specifically, the feature information generation unit 105b calculates the feature amount ac of complexity using a 4×4 coefficient block 1002 in the sub-band 1HL sub-band, a 4×4 coefficient block 1003 in the sub-band 1LH, and a 4×4 coefficient block 1004 in the sub-band 1HH sub-band, which are spatially at the same position, in accordance with the following formulae (10)-(13).

$$ac\_ 1 HL = \{ ABS ( B 1 ) + ABS ( B 2 ) + ABS ( B 3 ) + … + ABS ( B 16 ) \} / 16 \qquad ( 10 )$$

$$ac\_ 1 LH = \{ ABS ( C 1 ) + ABS ( C 2 ) + ABS ( C 3 ) + … + ABS ( C 16 ) \} / 16 \qquad ( 11 )$$

$$ac\_ 1 HH = \{ ABS ( D 1 ) + ABS ( D 2 ) + ABS ( D 3 ) + … + ABS ( D 16 ) \} / 16 \qquad ( 12 )$$

$$ac = MAX ( ac\_ 1 LH , ac\_ 1 HH ) \qquad ( 13 )$$

Here, ABS () is a function that returns an absolute value of an argument, and MAX () is a function that returns the largest value among given arguments (average values ac_1HL, ac_1LH, and ac_1HH).

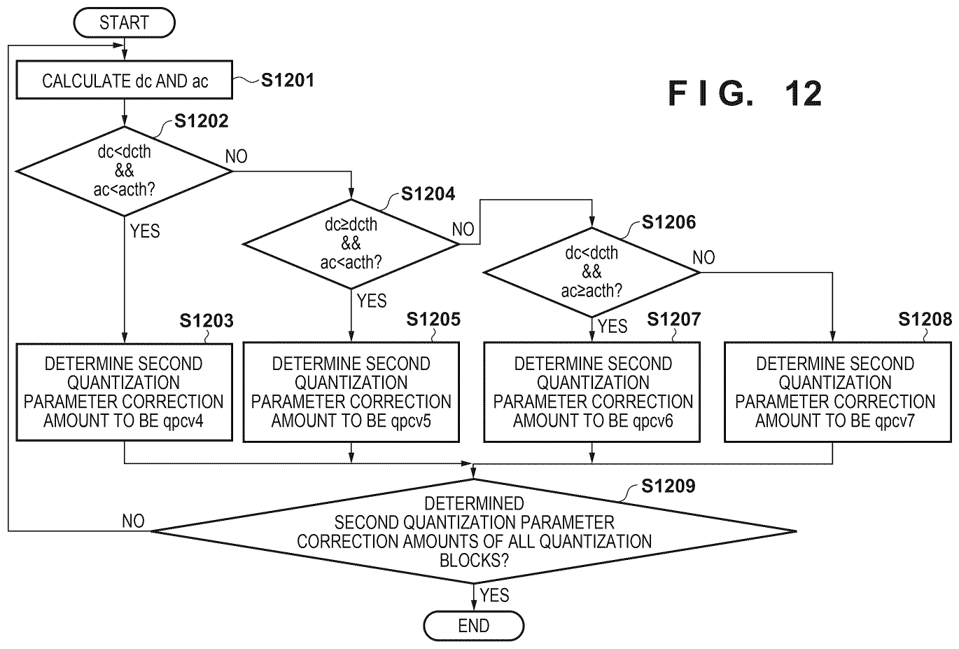

A method of determining a second quantization parameter correction amount, which is implemented by the feature information generation unit 105b, will be described with reference to a feature classification table shown in FIG. 11. In FIG. 7, dcth is a threshold for the light and dark determination, and acth is a threshold for the complexity determination related to flatness and complexity. Each threshold is a parameter that can be arbitrarily set in accordance with, for example, a bit depth of an image, and the feature of the quantization target block is classified in accordance with a magnitude relationship between these two thresholds and dc, ac. qpcv4-qpcv7 are second quantization parameter correction amounts that are applied for respective features that have been classified in accordance with the magnitude relationship with each threshold. The magnitude relationship among the second quantization parameter correction amounts for respective feature amounts of complexity is as follows, for example.

$$qpcv 4 \leq qpcv 5 \leq qpcv 6 \leq qpvc 7$$

In consideration of visual characteristics, the second quantization parameter correction amount is set so that qpcv4 in a dark and flat area is finest (smallest), and qpcv7 in a light and complex area is coarsest (largest).

Next, processing for determination of a second quantization parameter correction amount by the feature information generation unit 105b will be described with reference to a flowchart of FIG. 12.

In S1201, the feature information generation unit 105b calculates the feature amounts dc and ac of the quantization target block in accordance with formulae (9)-(13) presented earlier.

In S1202, the feature information generation unit 105b executes magnitude determination processing with respect to the feature amount dc and the threshold dcth, and to the feature amount ac and the threshold acth. Then, in a case where the feature information generation unit 105b has determined that dc is smaller than dcth and ac is smaller than acth, processing proceeds to S1203; otherwise, processing proceeds to S1204.

In S1203, as the quantization target block is a dark and flat area, the feature information generation unit 105b determines the second quantization parameter correction amount thereof to be qpcv4.

In S1204, the feature information generation unit 105b executes the magnitude determination processing with respect to the feature amount dc and the threshold dcth, and to the feature amount ac and the threshold acth. In a case where the feature information generation unit 105b has determined that the feature amount dc is equal to or larger than the threshold dcth, and the feature amount ac is smaller than the threshold acth, processing proceeds to S1205; otherwise, processing proceeds to S1206.

In S1205, as the quantization target block is a light and flat area, the feature information generation unit 105b determines the second quantization parameter correction amount thereof to be qpcv5.

In S1206, the feature information generation unit 105b executes the magnitude determination processing with respect to the feature amount dc and the threshold dcth, and to the feature amount ac and the threshold acth. In a case where the feature information generation unit 105b has determined that the feature amount dc is smaller than the threshold dcth, and the feature amount ac is equal to or larger than the threshold acth, processing proceeds to S1207; otherwise, processing proceeds to S1208.

In S1207, as the quantization target block is a dark and complex area, the feature information generation unit 105b determines the second quantization parameter correction amount thereof to be qpcv6.

In S1208, as the quantization target block is a light and complex area, the feature information generation unit 105b determines the second quantization parameter correction amount thereof to be qpcv7.

In S1209, the feature information generation unit 105b determines whether the second quantization parameter correction amounts of all quantization target blocks have been determined. In a case where the second quantization parameter correction amounts of all quantization target blocks have been determined, the present processing is completed; otherwise, processing returns to S1201, and processing for determining a second quantization correction parameter of the quantization target block that has not been processed yet is executed.

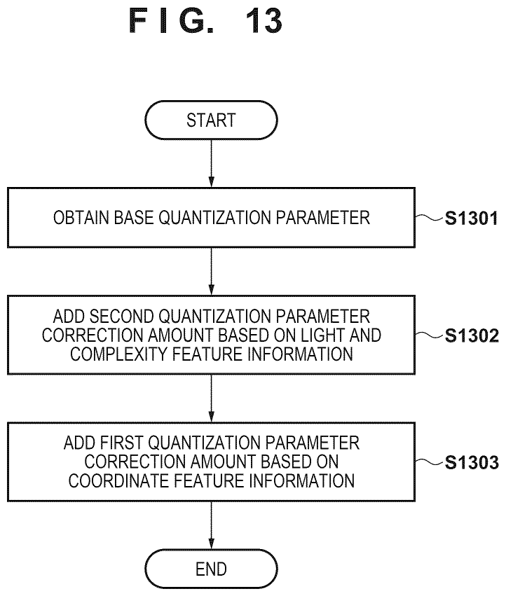

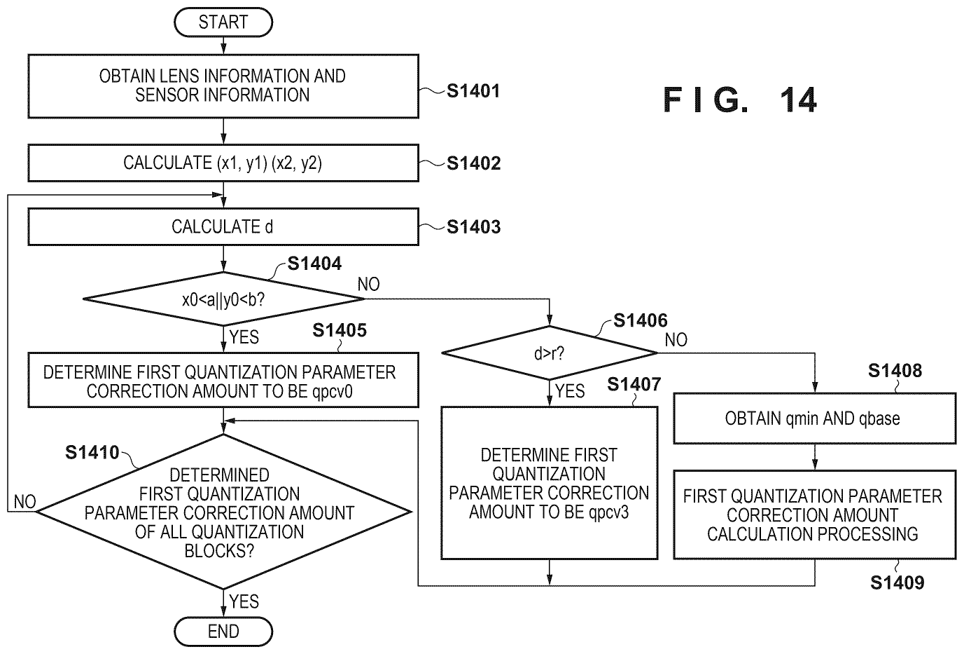

Finally, processing for outputting a quantization parameter, which is executed by the quantization parameter correction unit 105c, will be described with reference to a flowchart of FIG. 13.

In S1301, the quantization parameter correction unit 105c obtains a base quantization parameter from the base quantization parameter determination unit 105a.

Then, in S1302, the quantization parameter correction unit 105c adds the second quantization parameter correction amount supplied from the feature information generation unit 105b to the base quantization parameter obtained in S1301.

In S1303, the quantization parameter correction unit 105c adds the first quantization parameter correction amount supplied from the control unit 101 to the result of addition calculated in S1302. Then, the quantization parameter correction unit 105c outputs the result of the foregoing addition as a corrected quantization parameter to the quantization unit 106.

The quantization unit 106 quantizes coefficients inside a quantization target sub-band of each plane using the corrected quantization parameter supplied from the quantization parameter correction unit 105c and a quantization step value that is decided in accordance with the type of the quantization target sub-band. Here, as described earlier, the types of sub-bands are 3LL, 3HL, 3LH, 3HH, 2HL, 2LH, 2HH, 1HL, 1LH, and 1HH. The magnitude relationship among the quantization step values used is roughly 3LL≤3HL, 3LH, 3HH≤2HL, 2LH, 2HH≤1HL, 1LH, 1HH. Note that it is sufficient to set the relationship among corrected quantization parameters, the types of sub-bands, and the quantization step values that are actually used as a table.

Furthermore, in addition processing of S1302 and S1303, clip processing is executed using an upper limit value or a lower limit value of the quantization parameter. This makes it possible to execute addition processing that prevents overflow and underflow of the quantization parameter.

As described above, the encoding efficiency can be increased by classifying a VR image in accordance with image features based on coordinates and image features that use light and complexity, and correcting a quantization parameter in accordance with the degree of importance of image quality in each classified area.

In the present embodiment, a quantization method is applied in a case where dual-eye lenses including two optical systems capable of shooting a right image and a left image with parallax are attached. In a case where the dual-eye lenses are not attached, it is sufficient to perform only quantization control that uses image features based on light and complexity, without performing quantization control that uses image features based on coordinates.

Also, although the size of the quantization target block has been described as 16×16 pixels in RAW image data in the present embodiment, the block size is not limited to this. Furthermore, in generation of feature information that uses a wavelet coefficient, too, the size of the quantization target block has been described as the 4×4 coefficient in a sub-band of a decomposition level 1, but the block size is not limited to this. It is to be understood that, for the purpose of simplifying the description by using a uniform quantization block size, the same size is used so that the quantization target block size of 16×16 pixels and the 4×4 coefficient in the sub-band of the level 1 are in the same coordinate relationship.

Moreover, in a case where the quantization block runs over an edge of an image, processing may be executed with respect to only pixels that do not meet the original block size. Alternatively, processing may be executed by interpolating pixels that do not meet the original block size with use of mirror pixels and copy pixels

The present embodiment has been described using an example in which image features based on coordinates are classified into four regions: the inner circumference area, the outer circumference area, the shaded area, and the OB area. Furthermore, the description has been provided using an example in which image features that use light and complexity are also classified into a total of four areas: two stages that are light and dark, and two stages that are flat and complex. However, the number of areas into which features are classified is not limited to this, and the features may be increased. In this case, it is sufficient to prepare thresholds that are necessary for classification into multiple stages, and perform classification in accordance with a determination of whether a feature is equal to or smaller than a threshold, or equal to or larger than a threshold.

Although the present embodiment has been described using a method in which the control unit 101 outputs a first quantization parameter correction amount to the quantization control unit 105, a classification map indicating to which area the quantization target block belongs may be output. In this case, a quantization parameter correction amount is determined in the quantization parameter correction unit 105c based on the classification map.

Note that although the above embodiment has described an example in which the decomposition level is 3, there are no particular restrictions on the decomposition level. In a case where the wavelet transform is executed to a decomposition level n by executing the wavelet transform n times, data that is configured based on coefficients representing the same spatial position in the sub-bands nLL, nHL, nLH, nHH, . . . , 1HL, 1LH, and 1HH is the quantization target block.

### Second Embodiment

A second embodiment will be described. The present embodiment is different from the first embodiment in a method of dividing an area inside an image circle, and a method of determining a first quantization parameter correction amount. In the first embodiment, only two areas inside an image circle, namely an inner circumference area and an outer circumference area, are classified using a distance from the central coordinates and an arbitrary threshold, and a first quantization parameter correction amount of a fixed pattern that has been prepared in advance is set. Therefore, to finely divide an area inside an image circle, it is necessary to increase thresholds and first quantization parameter correction amounts in accordance with the number of areas, and there is a concern that a circuit scale becomes bloated with the inclusion of the magnitude determination processing for the central coordinates and the thresholds. In view of this, in the present second embodiment, a description is given of a method which can more finely set a first quantization parameter correction amount inside an image circle in accordance with a distance from the central coordinates, and which also can automatically determine the first quantization parameter correction amount without the magnitude determination processing.

FIG. 15 shows a configuration of an image processing apparatus according to the second embodiment. With reference to FIG. 15, the following describes encoding processing based on the H.264 standard by an image processing apparatus 1500 according to the present second embodiment. In the configuration of the first embodiment, data of the Bayer array is separated into pieces of plane data, and frequency transformation is performed with respect to the pieces of plane data. Furthermore, as the wavelet transform is used in the frequency transformation, sub-band data is sub-sampled in the horizontal and vertical directions in accordance with the number of decomposition levels. As a result, the unit of control on a quantization block is 16×16 pixels of the Bayer, 8×8 pixels in a plane, the 4×4 coefficient inside a sub-band of a decomposition level 1, the 2×2 coefficient inside a sub-band of a decomposition level 2, and the 1×1 coefficient inside a sub-band of a decomposition level 1; thus, the block size varies in each processing step. According to the H.264 standard of the present embodiment, the unit of encoding processing is defined by macroblocks, and therefore, processing is executed in units of a macroblock size for anything, be it pixels or a coefficient after orthogonal transformation. A uniform unit of 16×16 pixels is consistently used for an encoding block and a quantization target block in the present embodiment. A detailed description related to processing units that are similar to those of the first embodiment is omitted, and symbols of parameters and the like are also the same as those of the first embodiment.

An image capturing unit 1501 transforms captured data of VR180, which has been obtained via optical systems of dual-eye lenses, from an RGB space representation to a YCbCr space representation, and stores a post-transformation image into a target image memory 1502.

A control unit 1503 corresponds to the control unit 101 of the first embodiment. The control unit 1503 outputs information of a compression ratio to a quantization control unit 1504 in response to an instruction input from a user via an operation unit 1520. Also, the control unit 1503 obtains lens information of the image capturing unit 1501, and calculates the central coordinates of a forming point of each of the left and right images. Then, once the central coordinates of each of the left and right images have been determined, the control unit 1503 determines a first quantization parameter correction amount in accordance with a distance to a quantization target block, and outputs the same to the later-described quantization control unit 1504. The details related to a method of determining the first quantization parameter correction amount will be described later.

The quantization control unit 1504 corrects a quantization parameter by adding the first quantization parameter correction amount to a base quantization parameter input from the control unit 1503. Then, the quantization control unit 1504 outputs the corrected quantization parameter to a quantization unit 1508.

A prediction unit 1505 determines a predictive encoding method for an encoding target block, which is a unit of encoding, and generates a predicted image. Here, the encoding method includes intra-screen predictive encoding in which encoding is performed only by prediction of an image inside a frame, and inter-screen predictive encoding in which encoding is performed including prediction of images between frames.

In a case where the intra-screen predictive encoding is performed, an encoding target block image, which is the unit of encoding, is read out from the target image memory 1502. The prediction unit 1505 reads out encoded pixel data that neighbors the encoding target block (pixel data before application of a deblocking filter 1512, which is output from a later-described adder 1511) from a reference image memory 1513, performs block matching with each of generated intra-screen predicted images corresponding to a plurality of prediction modes, and outputs an intra-screen predicted image with the highest encoding efficiency to a subtractor 1506.

On the other hand, in a case where the inter-screen predictive encoding is performed, an encoding target block image, which is the unit of encoding, is read out from the target image memory 1502, and output to the prediction unit 1505. Also, an encoded reference image from the past is read out from the reference image memory 1513, and output to the prediction unit 1505. The prediction unit 1505 executes motion search processing based on the encoding target block image and the reference image, and detects motion vectors related to the reference image. An inter-screen predicted image is generated using the detected motion vectors and the reference image obtained from the reference image memory 1513, and output to the subtractor 1506.

The predicted image generated by the prediction unit 1505 and the encoding target block image that has been read out from the target image memory 1502 are input to the subtractor 1506, which generates a difference image of pixel values in the block image of the encoding target image and the predicted image. Then, the generated difference image is output to an orthogonal transformation unit 1507.

The orthogonal transformation unit 1507 applies orthogonal transformation to the input difference image of pixel values. Then, a transformation coefficient is output to the quantization unit 1508.

Using a quantization parameter input from the quantization control unit 1504, the quantization unit 1508 outputs the transformation coefficient after the quantization to an entropy encoding unit 1514.

Also, the transformation coefficient quantized by the quantization unit 1508 is also input to an inverse quantization unit 1509. The inverse quantization unit 1509 inverse-quantizes the input transformation coefficient, and outputs the transformation coefficient after the inverse quantization to an inverse orthogonal transformation unit 1510.

The inverse orthogonal transformation unit 1510 applies inverse orthogonal transformation processing to the coefficient after the inverse quantization input from the inverse quantization unit 1509. Then, data after the transformation processing is output to the adder 1511.

The adder 1511 adds data to which the inverse orthogonal transformation has been applied, and the predicted image generated by the prediction unit 1505. The data after the addition, which is a decoded re-configured image, is input to the reference image memory 1513, and used in generation of an intra-screen predicted image.

Furthermore, the deblocking filter 1512 executes processing for alleviating block distortion, which occurs at the time of encoding, with respect to the decoded re-configured image, and the decoded re-configured image is stored as a reference image used during the inter-screen predictive encoding into the reference image memory 1513.

The entropy encoding unit 1514 performs entropy encoding of the post-quantization transformation coefficient input from the quantization unit 1508.

Encoded data input from the entropy encoding unit 1514 is recorded into a recording medium 1515.

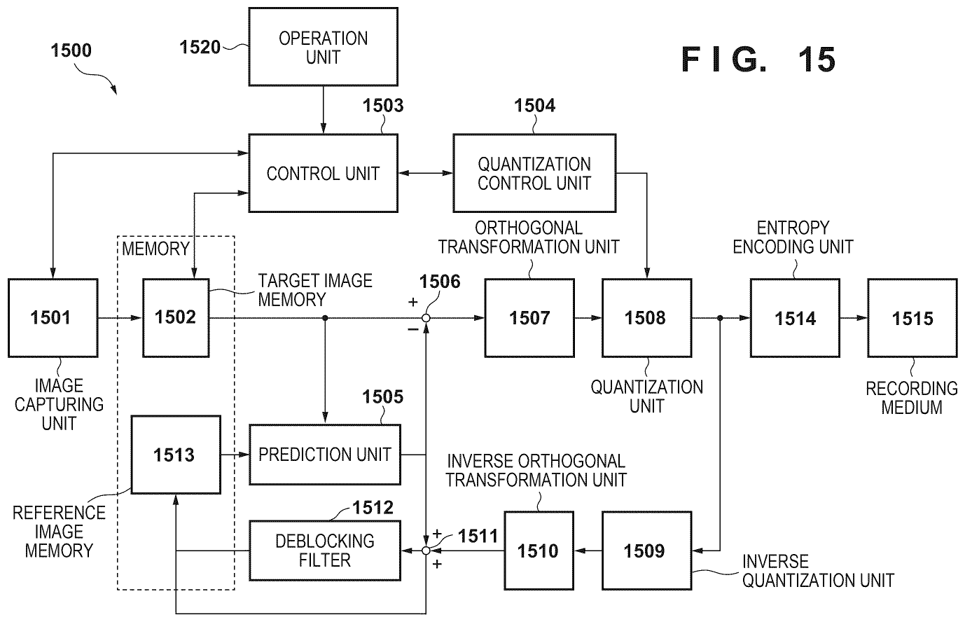

Now, processing for determining a first quantization parameter correction amount, which is executed by the control unit 1503, will be described with reference to a flowchart of FIG. 14. The difference from the first embodiment is the addition of S1408 and S1409. A detailed description related to processing steps that are similar to those of the first embodiment is omitted, and symbols of parameters and the like are also the same as those of the first embodiment.

In S1401, the control unit 1503 obtains lens information and sensor information of the image capturing unit 1501.

In S1402, using the lens information obtained in S1401, the control unit 1503 calculates the central coordinates of the left and right image circles that take into consideration a center displacement.

In S1403, the control unit 1503 calculates a distance d using the central coordinates of the left and right image circles obtained in S1402, and the coordinates of pixels inside a quantization block. The pixel coordinates based on which this distance d has been calculated are (x0, y0).

S1404 is processing in which the control unit 1503 determines whether a quantization target block is in the OB area using information of the OB area obtained in S1401. In a case where the control unit 1503 has determined that x0 is smaller than a, or y0 is smaller than b, processing proceeds to S1405; otherwise, processing proceeds to S1406.

In S1405, the control unit 1503 regards that the quantization target block is inside the OB area, and determines the quantization parameter correction amount thereof to be qpcv0.

S1406 is processing in which the control unit 1503 determines whether the quantization target block is in the shaded area. In a case where the control unit 1503 has determined that the distance d is longer than a radius r of a circular image, processing proceeds to S1407; otherwise, processing proceeds to S1408.

In S1407, the control unit 1503 regards that the quantization target block is inside the shaded area, and determines the quantization parameter correction amount to be qpcv3.

In S1408, the control unit 1503 obtains a quantization parameter setting lower limit qmin (>0), and a base quantization parameter qbase (>0). Here, the quantization parameter setting lower limit qmin is a lower limit value of settings of quantization parameters corresponding to compression ratios, and is an arbitrary setting parameter. Also, as stated earlier, qbase is a quantization parameter applied to an entire screen based on a compression ratio.

In S1409, the control unit 1503 assumes that the quantization target block is inside the image circle, and determines a first quantization parameter correction amount in accordance with the following formula (14).

$$qpcv = d / r * ( qmin - qbase ) \qquad ( 14 )$$

Here, “d/r” in the formula represents a distance ratio indicating to what extent the quantization target block is distanced from the central coordinates. As qmin<qbase, the first quantization parameter correction amount qpcb has a value of 0 or a negative value.

In a case where the quantization target block is at the central coordinates, d=0, and the first quantization parameter correction amount qpcv is 0. Also, when the quantization target block is positioned on the image circle, d=r, and the first quantization parameter correction amount qpcv becomes largest in the negative direction. The use of such a calculation formula makes it possible to set a quantization parameter that achieves finer quantization with a decreasing distance to the outer circumference area inside the image circle, and eliminates the need for the distance thresholds and the magnitude determination processing for the thresholds, which have been described in the first embodiment. Note that a calculation method for the quantization parameter correction amount in S1409 is not limited to formula 14, and may be another calculation method that uses a distance ratio.

S1410 determines whether the quantization correction parameters of all quantization target blocks have been determined. In a case where the quantization correction parameters of all quantization target blocks have been determined, processing is completed; otherwise, processing returns to S1403, and thereafter, processing for determining a quantization correction parameter of the next quantization target block is executed.

As described above, the use of a calculation formula that uses a distance ratio indicating to what extent the quantization target block is distanced from the central coordinates, makes it possible to set a finer quantization parameter correction amount corresponding to a distance in an area inside an image circle. Furthermore, as there are few setting parameters related to processing and the magnitude determination is unnecessary, a circuit scale can be suppressed.

Note that in the second embodiment, too, clipping is performed similarly to the first embodiment so that the corrected quantization parameter has a value within a permitted range.

Furthermore, application to a standardized encoding method, such as H.264, is also possible.

According to the present disclosure, a data amount at the time of recording of a VR image can be encoded at a high compression ratio while suppressing deterioration in the image quality of an image to be displayed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image processing apparatus that obtains an image from an image sensor, the image being formed by first and second optical systems for capturing a VR image, and encodes the image, comprising one or more processors that execute a program stored in a memory and thereby function as:
a quantization unit configured to quantize image data obtained by the image sensor in units of a block of a predetermined size;
a quantization control unit configured to determine a quantization parameter used by the quantization unit, and set the quantization parameter in the quantization unit; and
an encoding unit configured to encode post-quantization data obtained by the quantization unit,
wherein
the quantization control unit includes
a calculation unit configured to calculate positions and sizes of two circular images which have been formed by the first and second optical systems and which are included in the VR image, and
a determination unit configured to determine a quantization parameter of a quantization target block based on a position of the quantization target block and on the positions and the sizes of the two respective circular images.

2. The image processing apparatus according to claim 1, wherein
the determination unit determines a correction amount ΔQ for correcting a base quantization parameter Q based on the position of the quantization target block, and on central coordinates and radiuses indicating the positions and the sizes of the two respective circular images,
the correction amount ΔQ includes ΔQ1, ΔQ2, and ΔQ3 that have a magnitude relationship ΔQ2≤ΔQ1≤ΔAQ3, and
the determination unit determines
ΔQ1 as the correction amount ΔQ in a case where the position of the quantization target block is in the first or the second circular image and a distance from the central coordinates thereof to the position is equal to or shorter than a threshold,
ΔQ2 as the correction amount ΔQ in a case where the position of the quantization target block is in the first or the second circular image and the distance from the central coordinates thereof to the position is equal to or longer than the threshold, and
ΔQ3 as the correction amount ΔQ in a case where the position of the quantization target block is in a shaded area.

3. The image processing apparatus according to claim 1, wherein
the determination unit determines a correction amount ΔQ for correcting a base quantization parameter Q based on distances d between the position of the quantization target block and central coordinates of the two respective circular images, and on radiuses r of the two respective circular images, and
provided that a predetermined lower limit value for setting a quantization parameter is qmin and a base quantization parameter is qbase, the determination unit determines
ΔQ3 as the correction amount ΔQ in a case where the distance d is longer than a distance r from a central coordinate to an outer circumference of a circular image, and
d/rx×(qmin−qbase) as the correction amount ΔQ in a case where the distance d is equal to or shorter than a distance r from a central coordinate to an outer circumference of a circular image.

4. The image processing apparatus according to claim 2, wherein
the VR image includes an optical black area (an OB area), and
in a case where the position of the quantization target block is in the OB area, the determination unit determines ΔQ0 as the correction amount ΔQ, the ΔQ0 having a relationship ΔQ1≤ΔQ0≤ΔQ3.

5. The image processing apparatus according to claim 1, wherein
the circular images are outer circumferences of image circles formed by the first and second optical systems.

6. The image processing apparatus according to claim 1, wherein
the first and second optical systems are removable and attachable lenses, and
the one or more processors further function as a calculation unit configured to calculate central coordinates and radiuses of the two circular images using information unique to the lenses.

7. The image processing apparatus according to claim 2, wherein
the image sensor is a sensor including filters of a Bayer array,
the one or more processors further function as:
a transformation unit configured to transform an image of the Bayer array obtained by the image sensor into four planes, i.e., a plane Y representing luminance components, and planes C0, C1, and C2 representing color difference components; and
a frequency transformation unit configured to generate sub-bands of a decomposition level n by executing a wavelet transform n times with respect to each plane obtained by the transformation unit, the n times having been preset, and
the image processing apparatus regards data consisted of coefficients at the same spatial position in sub-bands of the decomposition level n, i.e., nLL, nHL, nLH, nHH, . . . , 1HL, 1LH, and 1HH obtained by the frequency transformation unit as the quantization target block.

8. The image processing apparatus according to claim 7, the one or more processors further function as:
a light and dark determination unit configured to determine whether the quantization target block is a light area or a dark area by comparing an average value of coefficients for the same space as the quantization target block in a sub-band 1LL of a decomposition level 1 obtained by the frequency transformation unit with a preset threshold for a light and dark determination;
a complexity determination unit configured to calculate average values ac_1HL, ac_1LH, and ac_1HH of coefficients for the same space as the quantization target block respectively in sub-bands 1HL, 1LH, and 1HH of the decomposition level 1 obtained by the frequency transformation unit, and determining whether the quantization target block is complex or flat by comparing a largest value among the calculated average values ac_1HL, ac_1LH, and ac_1HH with a preset threshold for a complexity determination; and
a second determination unit configured to determine a second correction amount Δ2Q for further correcting the base quantization parameter Q of the quantization target block in accordance with results of the determinations respectively made by the light and dark determination unit and the complexity determination unit,
wherein
the second correction amount Δ2Q includes ΔQ4, ΔQ5, ΔQ6, and ΔQ7 that have a magnitude relationship ΔQ4≤ΔQ5≤ΔQ6≤ΔQ7, and
the second determination unit determines
ΔQ4 as the second correction amount Δ2Q in a case where the quantization target block is in the dark area and is flat,
ΔQ5 as the second correction amount Δ2Q in a case where the quantization target block is in the light area and is flat,
ΔQ6 as the second correction amount Δ2Q in a case where the quantization target block is in the dark area and is complex, and
ΔQ7 as the second correction amount Δ2Q in a case where the quantization target block is in the light area and is complex.

9. A control method for an image processing apparatus that obtains an image, from an image sensor, the image being formed by first and second optical systems for capturing a VR image, and encodes the image, comprising:
quantizing image data obtained by the image sensor in units of a block of a predetermined size;
determining a quantization parameter used in the quantization step;
setting the quantization parameter in the quantizing step; and
encoding post-quantization data obtained in the quantizing,
wherein
the determining includes
calculating positions and sizes of two circular images which have been formed by the first and second optical systems and which are included in the VR image, and
determining a quantization parameter of a quantization target block based on a position of the quantization target block and on the positions and the sizes of the two respective circular images.

10. A computer-readable medium storing a program that causes, when executed by one or more processors, the one or more processors to perform a control method for an image processing apparatus that obtains an image, from an image sensor, the image being formed by first and second optical systems for capturing a VR image, and encodes the image, comprising:
quantizing image data obtained by the image sensor in units of a block of a predetermined size;
determining a quantization parameter used in the quantization step;
setting the quantization parameter in the quantizing step; and
encoding post-quantization data obtained in the quantizing,
wherein
the determining includes
calculating positions and sizes of two circular images which have been formed by the first and second optical systems and which are included in the VR image, and
determining a quantization parameter of a quantization target block based on a position of the quantization target block and on the positions and the sizes of the two respective circular images.
